(19) United States
(12) Patent Application Publication
(10) Pub. No.: US 2010/0087091 A1
(43) Pub. Date: Apr. 8, 2010

(54) Electrical connector

(76) Inventor: Chien Ting Chen, Taoyuan Hsien (TW)

Correspondence Address: CHARLES E. BAXLEY, ESQUIRE, 90 JOHN STREET, SUITE 309, NEW YORK, NY, 10038, US

(21) Appl. No.: 12/583,566

(22) Filed: Aug. 21, 2009

(30) Foreign Application Priority Data
Oct. 2, 2008 (TW) 097217646

(51) Int. Cl. H01R 9/05

(52) U.S. Cl. 439/578

(57) ABSTRACT

An electrical connector includes an outer shell having a chamber formed in a housing, and having an engaging tongue for securing a coaxial cable to the outer shell, an insulating member engaged into the housing and includes a compartment and a socket opening for mounting a conductor terminal without special and predetermined machining or clamping devices, and the conductor terminal is engageable with an internal conductor of a coaxial cable, the conductor terminal includes a stationary contact blade and a pivot contact blade spaced from each other for engaging with the internal conductor of the coaxial cable and for allowing the internal conductor to be quickly coupled to the conductor terminal.

### BACKGROUND OF THE INVENTION

1. Field of the Invention

The present invention relates to an electrical connector, and more particularly to an electrical connector including an improved structure for allowing the parts of the electrical connector to be easily and quickly assembled together without special and predetermined machining or clamping devices.

2. Description of the Prior Art

Typical electrical connectors are normally provided and disposed on one end of a shielding cable and comprise a braid wire surrounding individual internal insulated wires which enable superior retention of the braid wire when the braid wire is folded back to expose the individual wires.

For example, U.S. Pat. No. 5,151,053 to Shinji et al. discloses one of the typical electrical connectors for shielding cable and comprising a tubular body, an electrically-conductive tubular terminal, a tubular casing covering the tubular body and the tubular terminal, a water-prevention plug fitted in the left end of the tubular casing, and a rear holder fitted on the right end of the tubular casing for coupling to a shielding cable.

However, a special and predetermined machining device is required to be provided and mounted for coupling and assembling the typical electrical connectors to the shielding cable, and the typical electrical connectors may not be easily and quickly assembled or connected to the shielding cable by the pincers or pliers or the like.

U.S. Pat. No. 6,790,082 to Obayashi discloses another typical coaxial cable connector comprising a connection terminal to be connected to an internal conductor of a coaxial cable and a metal shell for supporting the connection terminal via an insulating member establishes electrical connection between the internal conductor of the coaxial cable and the connection terminal by bending the connection terminal according to the respective bending forces of the shell and the connection terminal and making such connection terminal retain the internal conductor of the coaxial cable.

However, similarly, a special and predetermined machining device is required to be provided for coupling and assembling or bending the connection terminal and the shell, and the typical coaxial cable connector also may not be easily and quickly assembled or connected or bent to retain the internal conductor of the coaxial cable by the pincers or pliers or the like.

The present invention has arisen to mitigate and/or obviate the afore-described disadvantages of the conventional electrical connectors.

### SUMMARY OF THE INVENTION

The primary objective of the present invention is to provide an electrical connector including an improved structure for allowing the parts of the electrical connector to be easily and quickly assembled together without special and predetermined machining or clamping devices.

In accordance with one aspect of the invention, there is provided an electrical connector comprising an outer shell including a housing provided on a first end portion of the outer shell and having a chamber formed in the housing, and including an engaging tongue provided on a second end portion of the outer shell for securing a coaxial cable to the outer shell, an insulating member engaged into the chamber of the housing and retained in the chamber of the housing, the insulating member including a compartment and a socket opening formed in the insulating member, and a conductor terminal engaged into the compartment and the socket opening of the insulating member for engaging with an internal conductor of the coaxial cable and for allowing the conductor terminal and the insulating member to be easily and quickly assembled to the outer shell without specially designed and predetermined machining or clamping devices.

The conductor terminal includes a stationary contact blade and a pivot contact blade spaced from each other for forming a gap between the stationary and the pivot contact blades and for engaging with the internal conductor of the coaxial cable.

The conductor terminal includes at least one flap extended therefrom and includes a catch extended from the flap and extended into the gap of the conductor terminal for selectively engaging with the pivot contact blade and for anchoring and retaining the internal conductor of the coaxial cable between the stationary and the pivot contact blades.

The insulating member includes an orifice formed therein and communicative with the compartment of the insulating member for exposing the pivot contact blade and for allowing the pivot contact blade to be moved toward the internal conductor of the coaxial cable.

The insulating member includes an opening formed in a first end portion thereof and communicative with the compartment of the insulating member and aligned with the gap of the conductor terminal for receiving the coaxial cable.

The insulating member includes at least one latch extended therefrom for engaging with the conductor terminal and for anchoring and securing the conductor terminal to the insulating member.

The insulating member includes an inclined surface formed in an outer portion of the latch for facilitating a sliding engagement of the conductor terminal into the compartment of the insulating member.

The conductor terminal includes at least one contact blade extended therefrom and engaged into the socket opening of the insulating member. The outer shell includes at least one anchoring tongue extended therefrom for engaging with the insulating member and for anchoring and securing the insulating member to the outer shell.

The housing includes two separated walls having a cylindrical shape for receiving and engaging with the insulating member and for anchoring and securing the insulating member to the housing of the outer shell.

The outer shell includes a side wall having an opening formed therein, and the housing includes an extension extended from each of the walls and engaged into the opening of the side wall for anchoring the walls of the housing to the side wall. The insulating member includes a socket member having the socket opening formed in the socket member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an electrical connector in accordance with the present invention;

FIG. 2 is a partial exploded view of the electrical connector;

FIG. 3 is a perspective view of an outer shell of the electrical connector;

FIG. 4 is another partial exploded view of the electrical connector;

FIG. 5 is a cross sectional view of the electrical connector taken along lines 5-5 of FIG. 1;

FIG. 6 is a cross sectional view of the electrical connector taken along lines 6-6 of FIG. 5;

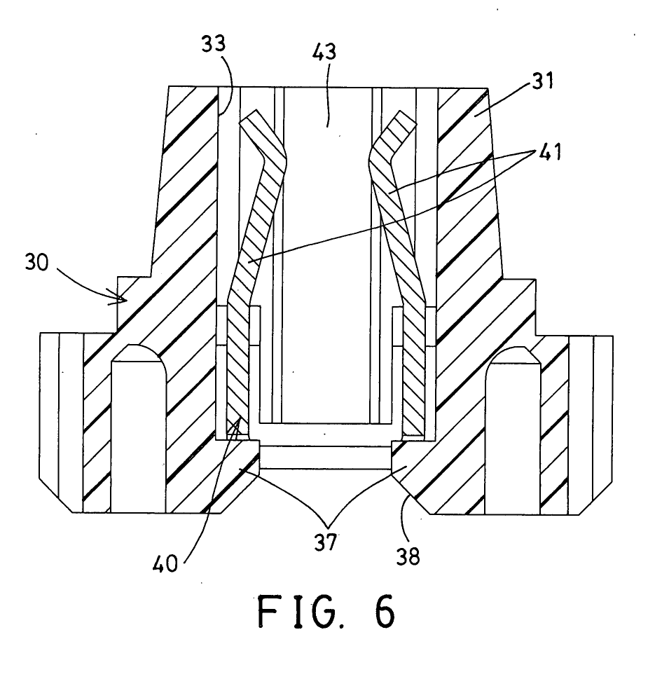

FIG. 7 is a cross sectional view similar to FIG. 5, illustrating the operation of the electrical connector;

FIG. 8 is a cross sectional view of the electrical connector taken along lines 8-8 of FIG. 7;

FIG. 9 is a partial top plan schematic view illustrating the coupling or assembling of the internal conductor of the coaxial cable to the connection terminal;

FIG. 10 is a partial exploded and cross sectional view illustrating the coupling or assembling of the other connector to the electrical connector; and

FIG. 11 is a cross sectional view illustrating the coupling or assembling of the other connector to the electrical connector.

### DETAILED DESCRIPTION OF THE PREFERRED EMBODIMENT

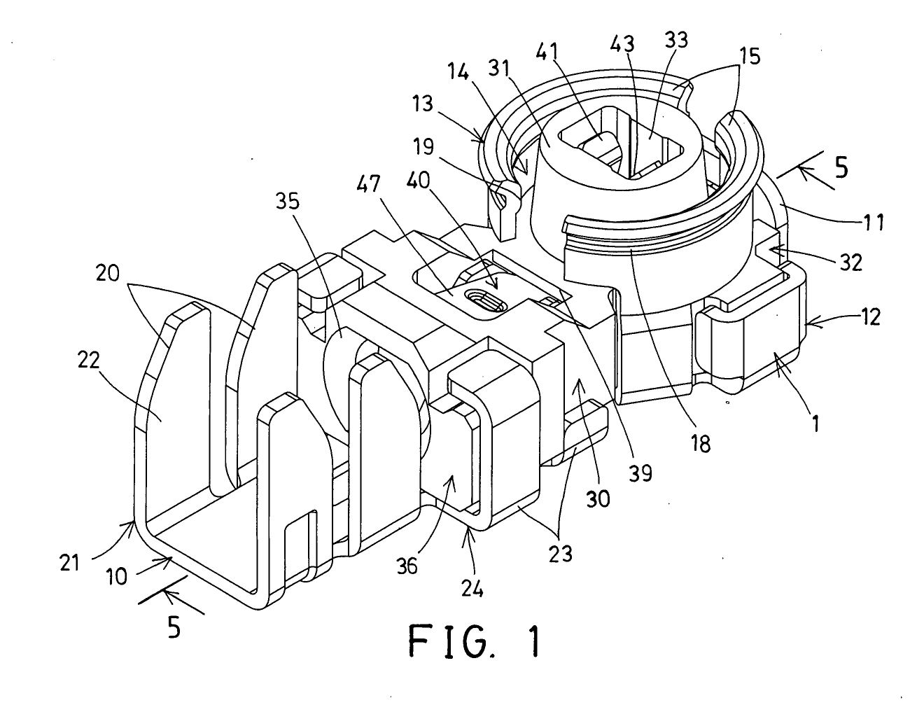

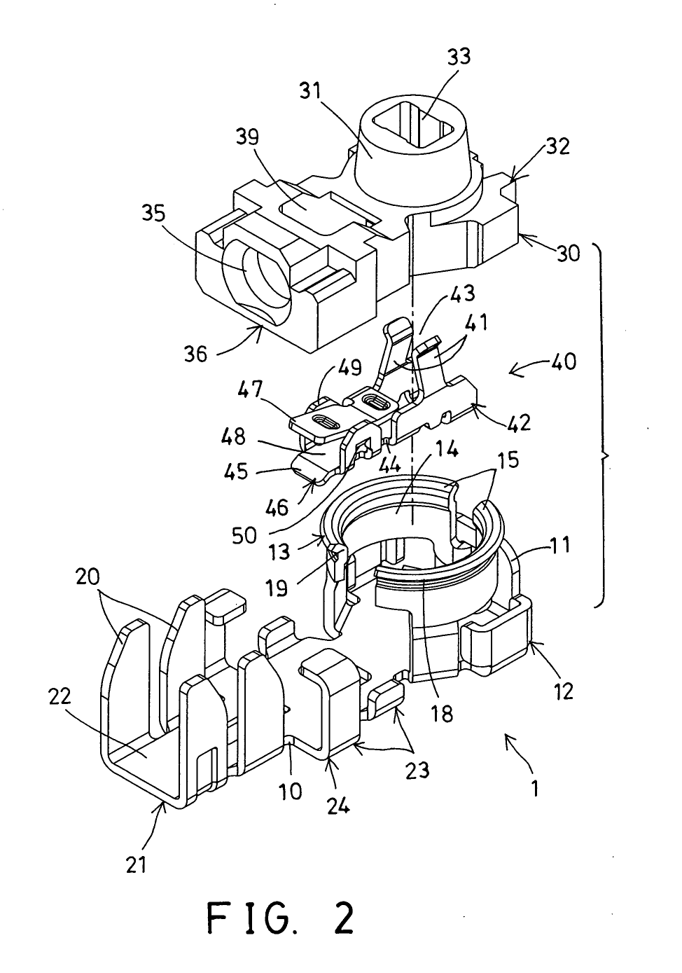

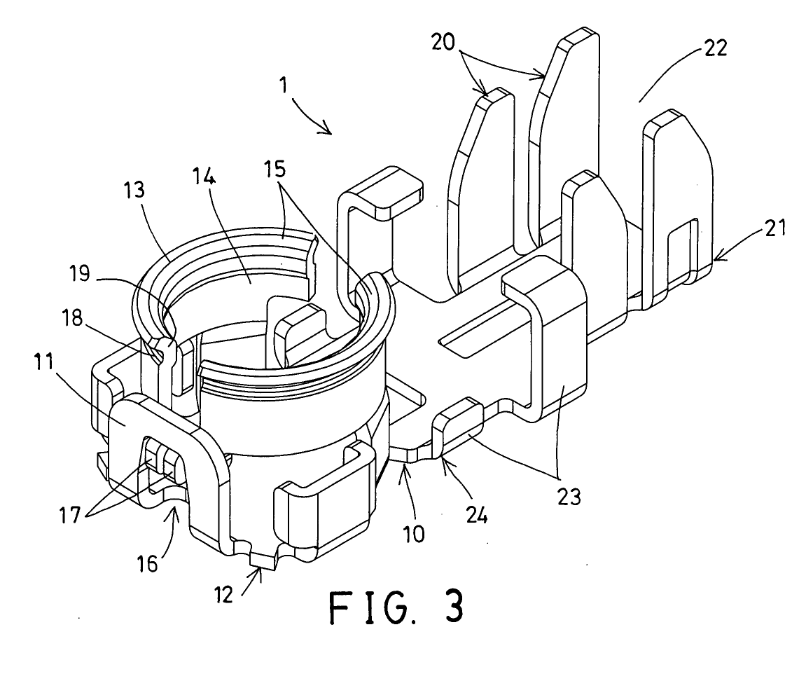

Referring to the drawings, and initially to FIGS. 1-3, an electrical connector in accordance with the present invention comprises an outer shell 1 including a base wall 10, and including a side wall 11 extended upwardly from one end or rear end portion 12 of the base wall 10, and including a housing 13 formed or provided or extended upwardly from the one end or rear end portion 12 thereof and located beside and spaced from the side wall 11, and including a chamber 14 formed in the housing 13 and formed or defined by two spaced or split or separated walls 15 which include a substantially cylindrical shape, the side wall 11 includes an opening 16 formed therein, and the housing 13 includes an extension 17 extended from each of the walls 15 and engaged with or into the opening 16 of the side wall 11 for anchoring the walls 15 of the housing 13 to the side wall 11.

For example, the split or separated walls 15 of the housing 13 include a suitable resilience and may be suitably moved or bent or tilted or folded toward or away from each other for forming and acting as a resilient housing 13, and the engagement of the extensions 17 of the walls 15 in the opening 16 of the side wall 11 allows the walls 15 to be suitably moved or bent or tilted or folded toward each other and may limit the outwardly bending or tilting or folding status or movement of the side wall 11 relative to the base wall 10 and may prevent the side wall 11 from overbending or from being damaged. The housing 13 include a peripheral recess 18 formed in the outer peripheral portion of the walls 15 and/or include a peripheral rib 19 extended radially and inwardly from the walls 15.

The outer shell 1 may further include one or more (such as two) pairs of engaging tongues 20 formed or provided or extended upwardly from the other end or front end portion 21 thereof and may include a space 22 formed in or between each pair of the engaging tongues 20, and may further include one or more (such as two) pairs of anchoring tongues 23 formed or provided or extended upwardly from the middle portion 24 thereof and may also include a space 22 formed between each pair of the anchoring tongues 23. The resilient housing 13 and/or the anchoring tongues 23 are provided for receiving or engaging with or anchoring an insulating member 30 to the housing 13, and the engaging tongues 20 are provided for receiving or engaging with or anchoring a cable 60, such as a coaxial cable 60 to the housing 13 which will be described in further details hereinafter.

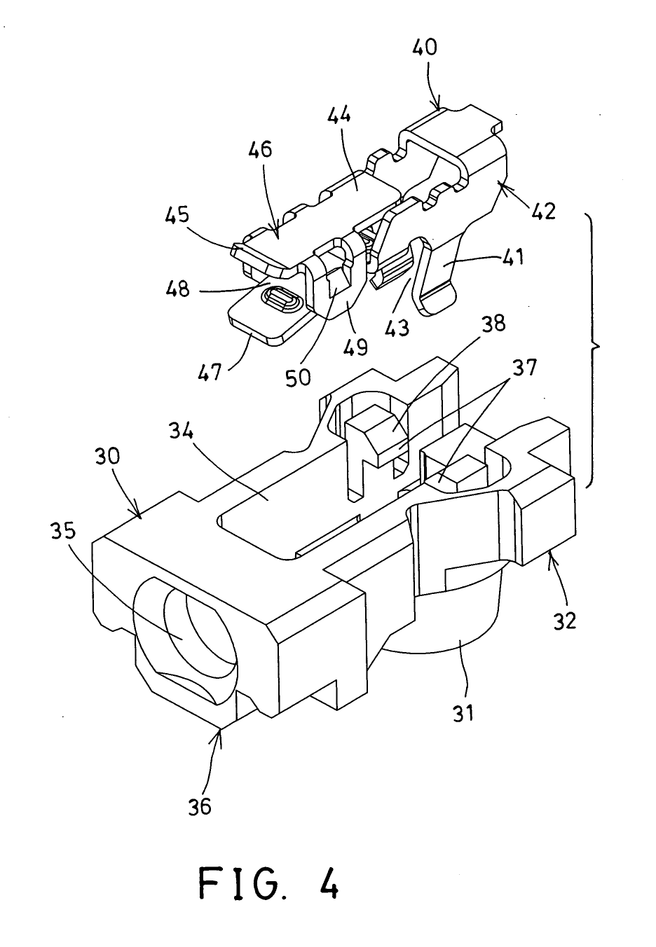

The insulating member 30 includes a socket member 31 extended from one end or rear end portion 32 thereof, and includes a socket opening 33 formed in the socket member 31, and includes a compartment 34 (FIG. 4) formed in the insulating member 30 and communicative with the socket opening 33 of the socket member 31, and includes an opening 35 formed or located in the other end or front end portion 36 thereof and communicative with the compartment 34 of the socket member 31 or the insulating member 30, and includes one or more (such as two) catches or latches 37 extended therefrom, such as extended into the compartment 34 of the socket member 31 for engaging with and for anchoring or securing or mounting a conductor terminal 40 to the socket member 31, and includes an inclined surface 38 formed in the outer portion of each of the latches 37 for facilitating the engagement of the conductor terminal 40 into the compartment 34 of the socket member 31.

The insulating member 30 may be engaged with or into the chamber 14 of the housing 13 by forcing through the resilient walls 15 of the housing 13 and may be stably anchored and retained in the chamber 14 of the housing 13 with the resilient walls 15 of the housing 13, and the other end or front end portion 36 of the insulating member 30 may be engaged with or into the space 22 of the anchoring tongues 23, and the anchoring tongues 23 and/or the side wall 11 of the outer shell 1 may be engaged with the insulating member 30 for stably anchoring and retaining the insulating member 30 in the housing 13 of the outer shell 1 and for preventing the insulating member 30 from moving relative to the base wall 10 and the outer shell 1.

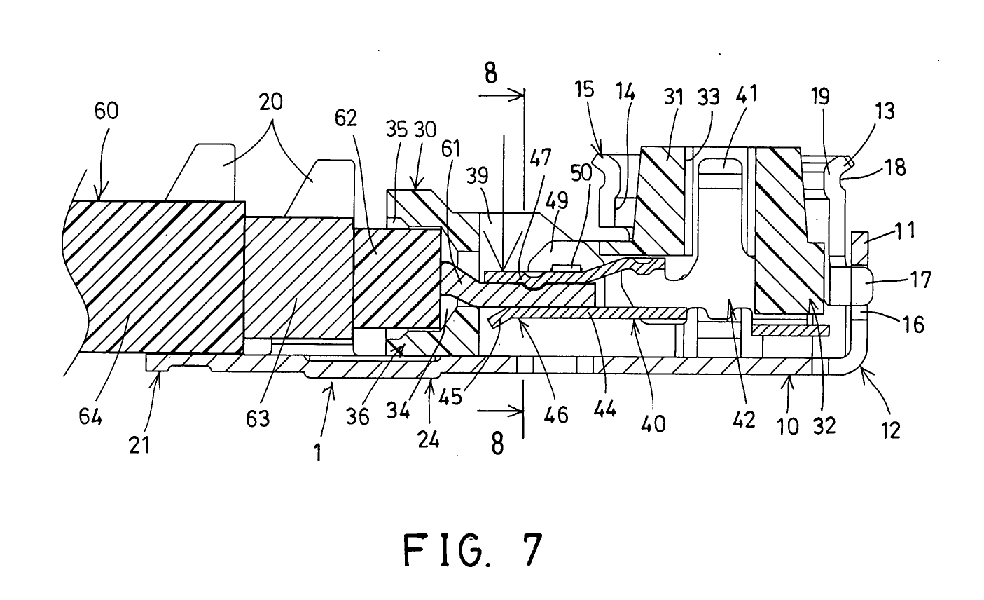

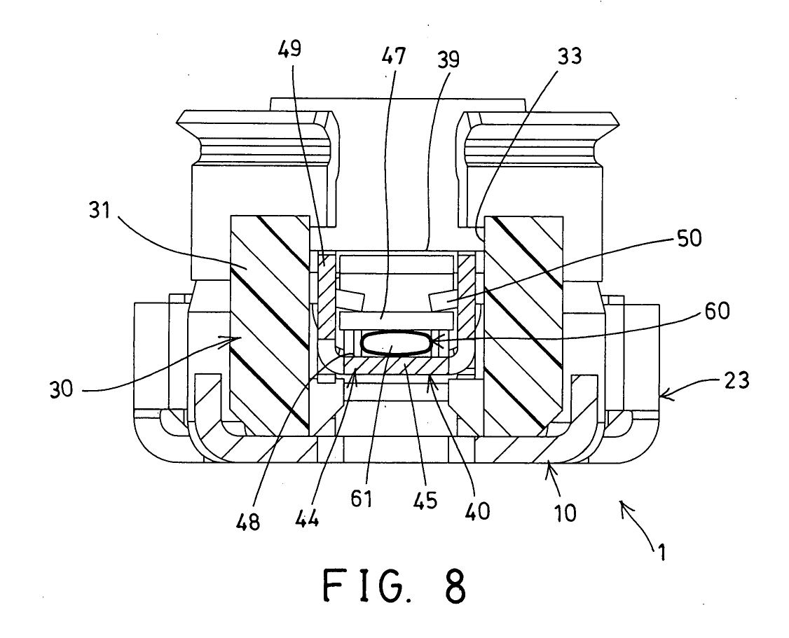

The conductor terminal 40 includes one or more (such as two) contact blades 41 extended therefrom, such as extended from one end or rear end portion 42 of the conductor terminal 40 and engaged with or into the socket opening 33 of the socket member 31, and includes an opening or gap 43 formed between the contact blades 41, and includes a base panel 44 having another stationary contact blade 45 formed or provided on the other end or front end portion 46 thereof, and includes a hinged or pivot or resilient contact blade 47 also formed or provided on the other end or front end portion 46 thereof and spaced from the stationary contact blade 45 and moveable toward or away from the stationary contact blade 45, and includes an opening or gap 48 formed between the contact blades 45, 47 for receiving or engaging with or anchoring an internal conductor 61 of the coaxial cable 60 (FIGS. 7, 8).

The conductor terminal 40 may further include one or more (such as two) flaps 49 extended from the other end or front end portion 46 thereof, and includes a catch 50 extended from each of the flaps 49 and extended into the gap 48 of the conductor terminal 40 for selectively engaging with the hinged or pivot or resilient contact blade 47 (FIGS. 7, 8) and for stably anchoring and retaining or clamping the internal conductor 61 of the coaxial cable 60 between the contact blades 45, 47. As shown in FIG. 7, the coaxial cable 60 includes an insulator 62 engaged onto the outer peripheral portion of the internal conductor 61, and includes an external conductor 63 engaged onto the outer peripheral portion of the insulator 62, and includes an exterior covering 64 engaged onto the outer peripheral portion of the external conductor 63.

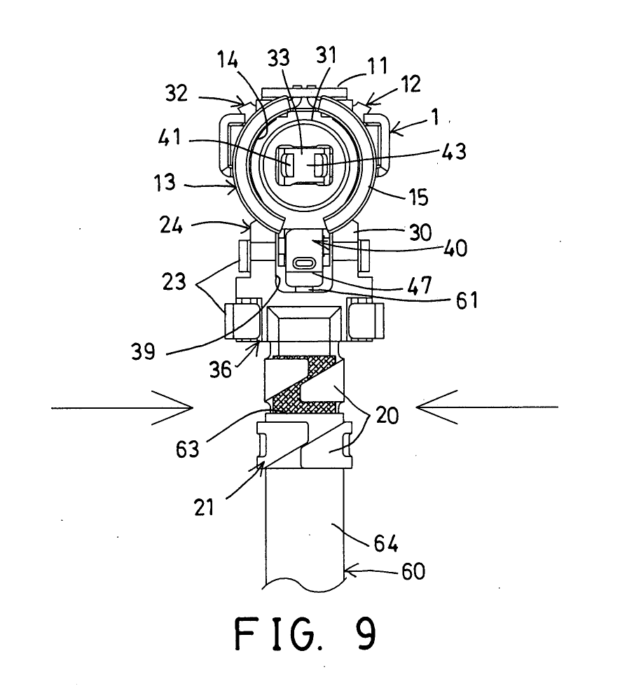

As shown in FIGS. 7 and 9, the external conductor 63 and the exterior covering 64 are received or engaged into the space 22 of the engaging tongues 20, and the engaging tongues 20 may be squeezed or clamped onto the external conductor 63 and the exterior covering 64 of the coaxial cable 60 for stably anchoring and retaining or clamping or mounting or securing or coupling the coaxial cable 60 to the outer shell 1, in which at least one of the engaging tongues 20 may be engaged with the external conductor 63 for electrically connecting or coupling the external conductor 63 to the outer shell 1, the internal conductor 61 of the coaxial cable 60 is electrically connected or coupled to the contact blades 45, 47 of the conductor terminal 40, and the insulating member 30 may be engaged between the outer shell 1 and the coaxial cable 60 for preventing the outer shell 1 and the internal conductor 61 of the coaxial cable 60 from being contacted with each other.

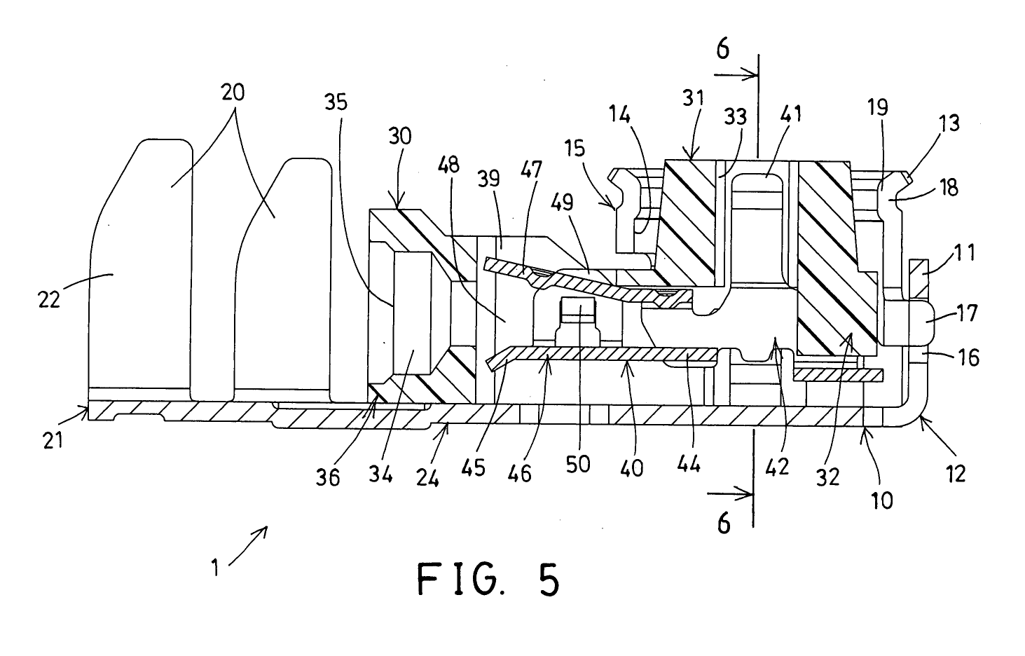

It is to be noted that, as shown in FIGS. 1, 5 and 7, the gap 48 of the conductor terminal 40 is faced or directed toward and aligned with the opening 35 of the insulating member 30 which is faced or directed toward and aligned with the space 22 of the engaging tongues 20, such that the internal conductor 61 of the coaxial cable 60 may be easily engaged into the gap 48 of the conductor terminal 40, and the insulator 62 may be easily engaged into the opening 35 of the insulating member 30, and the external conductor 63 and the exterior covering 64 may be easily engaged into the space 22 of the engaging tongues 20, and the engaging tongues 20 may then be squeezed or clamped onto the external conductor 63 and the exterior covering 64 of the coaxial cable 60 with pincers or pliers or the like for stably anchoring and retaining or clamping or mounting or securing or coupling the coaxial cable 60 to the outer shell 1.

As shown in FIGS. 1-2, 5 and 7-9, the insulating member 30 includes an opening or orifice 39 formed therein and communicative with the compartment 34 of the socket member 31 for exposing the resilient contact blade 47 and for allowing the resilient contact blade 47 to be moved or forced toward or onto the internal conductor 61 of the coaxial cable 60 after the internal conductor 61 of the coaxial cable 60 has been engaged into the gap 48 of the conductor terminal 40 such that the internal conductor 61 of the coaxial cable 60 may be easily and quickly secured and assembled to the conductor terminal 40 with pincers or pliers or screw drivers or the like, without special and predetermined machining or clamping device.

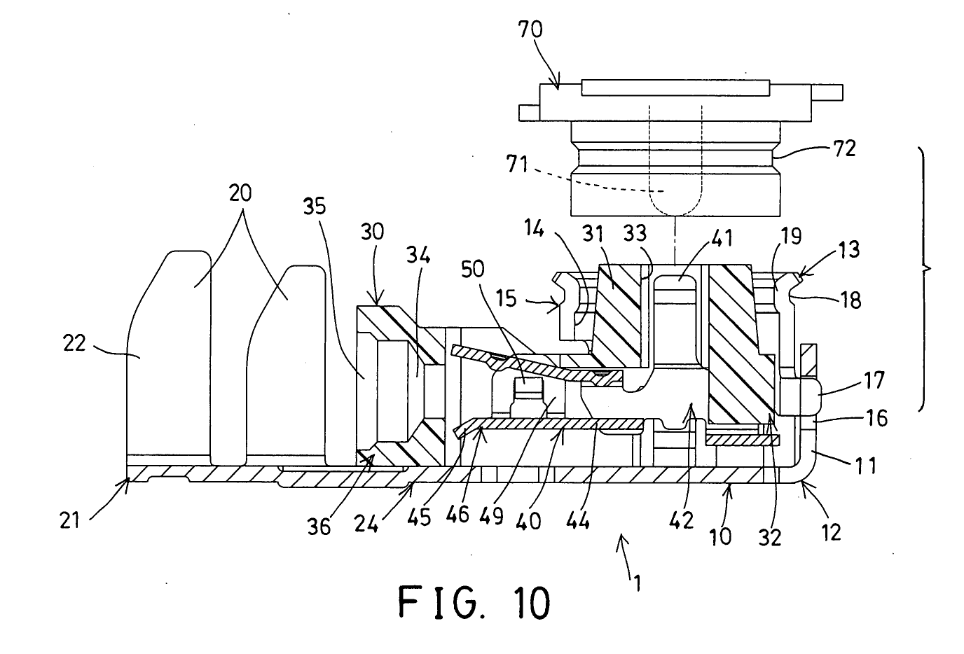

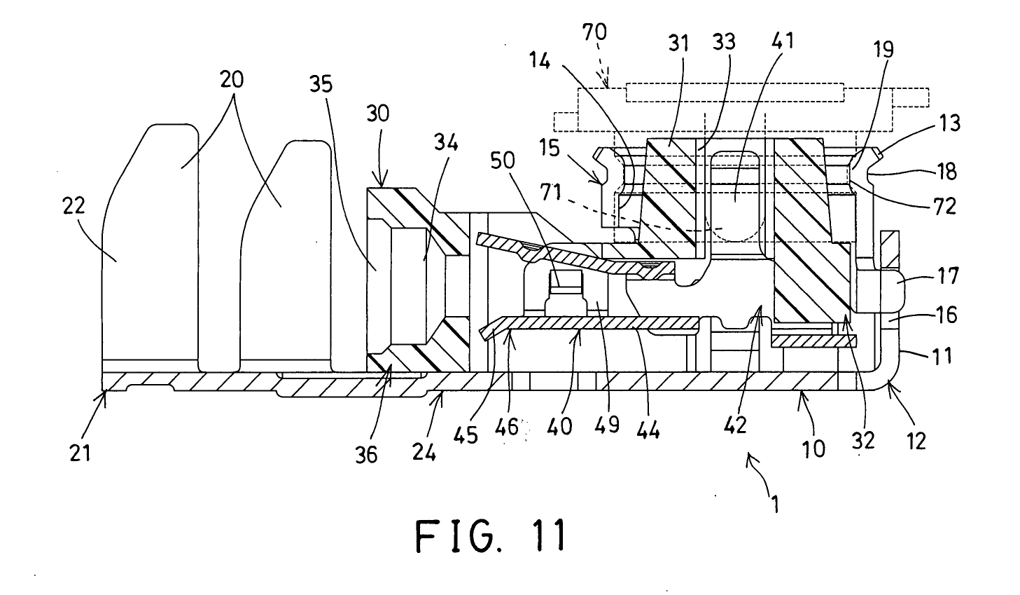

As shown in FIGS. 10 and 11, another electrical connector or plug 70 may further be provided and engageable with or into the chamber 14 of the housing 13 and/or engageable with or into the socket opening 33 of the socket member 31, and may include a prong 71 engaged into the socket opening 33 of the socket member 31, and may be engaged with or into the gap 43 that is formed between the contact blades 41, and may include a peripheral recess 72 formed in the outer peripheral portion of the plug 70 for engaging with the peripheral rib 19 of the walls 15 of the housing 13 which may anchor and retain the plug 70 to the socket member 31 and/or the housing 13 for stably anchoring and retaining the engagement of the prong 71 of the plug 70 with the contact blades 41 of the conductor terminal 40.

In operation, as shown in FIG. 4, the conductor terminal 40 may first be engaged with or into the compartment 34 and the socket opening 33 of the socket member 31 and may be stably anchored and retained in the compartment 34 of the insulating member 30 with the latches 37, and the insulating member 30 may then be engaged with or into the chamber 14 of the housing 13 and may be stably anchored and retained in the chamber 14 of the housing 13 with the resilient walls 15 of the housing 13 and/or the anchoring tongues 23 and/or the side wall 11 of the outer shell 1 without additional fasteners and working tools.

In addition, as shown in FIG. 7, the internal conductor 61 of the coaxial cable 60 may then be easily engaged into the gap 48 of the conductor terminal 40, and the insulator 62 may be easily engaged into the opening 35 of the insulating member 30, and the external conductor 63 and the exterior covering 64 may be easily engaged into the space 22 of the engaging tongues 20, and the engaging tongues 20 may then be squeezed and engaged or forced or clamped onto the external conductor 63 and the exterior covering 64 of the coaxial cable 60 (FIG. 9) with such as pincers or pliers or the like for stably anchoring and retaining or clamping or mounting or securing or coupling the coaxial cable 60 to the outer shell 1 without specially designed and/or predetermined machining or clamping devices.

Accordingly, the electrical connector in accordance with the present invention includes an improved structure for allowing the parts of the electrical connector to be easily and quickly assembled together without special and predetermined machining or clamping devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electrical connector comprising:
an outer shell including a housing provided on a first end portion of said outer shell and having a chamber formed in said housing, and including an engaging tongue provided on a second end portion of said outer shell for securing a coaxial cable to said outer shell,
an insulating member engaged into said chamber of said housing and retained in said chamber of said housing, said insulating member including a compartment and a socket opening formed in said insulating member, and
a conductor terminal engaged into said compartment and said socket opening of said insulating member for engaging with an internal conductor of said coaxial cable.

2. The electrical connector as claimed in claim 1, wherein said conductor terminal includes a stationary contact blade and a pivot contact blade spaced from each other for forming a gap between said stationary and said pivot contact blades and for engaging with said internal conductor of said coaxial cable.

3. The electrical connector as claimed in claim 2, wherein said conductor terminal includes at least one flap extended therefrom and includes a catch extended from said at least one flap and extended into said gap of said conductor terminal for selectively engaging with said pivot contact blade and for anchoring and retaining said internal conductor of said coaxial cable between said stationary and said pivot contact blades.

4. The electrical connector as claimed in claim 2, wherein said insulating member includes an orifice formed therein and communicative with said compartment of said insulating member for exposing said pivot contact blade and for allowing said pivot contact blade to be moved toward said internal conductor of said coaxial cable.

5. The electrical connector as claimed in claim 2, wherein said insulating member includes an opening formed in a first end portion thereof and communicative with said compartment of said insulating member and aligned with said gap of said conductor terminal for receiving said coaxial cable.

6. The electrical connector as claimed in claim 1, wherein said insulating member includes at least one latch extended therefrom for engaging with said conductor terminal and for anchoring and securing said conductor terminal to said insulating member.

7. The electrical connector as claimed in claim 6, wherein said insulating member includes an inclined surface formed in an outer portion of said at least one latch for facilitating an engagement of said conductor terminal into said compartment of said insulating member.

8. The electrical connector as claimed in claim 1, wherein said conductor terminal includes at least one contact blade extended therefrom and engaged into said socket opening of said insulating member.

9. The electrical connector as claimed in claim 1, wherein said outer shell includes at least one anchoring tongue extended therefrom for engaging with said insulating member and for anchoring and securing said insulating member to said outer shell.

10. The electrical connector as claimed in claim 1, wherein said housing includes two separated walls having a cylindrical shape for receiving and engaging with said insulating member and for anchoring and securing said insulating member to said housing of said outer shell.

11. The electrical connector as claimed in claim 10, wherein said outer shell includes a side wall having an opening formed therein, and said housing includes an extension extended from each of said walls and engaged into said opening of said side wall for anchoring said walls of said housing to said side wall.

12. The electrical connector as claimed in claim 1, wherein said insulating member includes a socket member having said socket opening formed in said socket member.
